(19) United States
(12) Patent Application Publication
(10) Pub. No.: US 2020/0178031 A1
(43) Pub. Date: Jun. 4, 2020

(54) SPEED BASED USER TRIGGERS

(71) Applicant: International Business Machines Corporation, Armonk, NY (US)

(72) Inventors: Lisa Seacat DeLuca, Baltimore, MD (US); Jeremy A. Greenberger, San Jose, CA (US)

(21) Appl. No.: 16/206,370

(22) Filed: Nov. 30, 2018

(51) Int. Cl. H04W 4/02; H04W 4/021; G06Q 30/02; H04W 68/00

(52) U.S. Cl. CPC H04W 4/027; H04W 4/021; H04W 4/20; H04W 68/005; G06Q 30/02

(57) ABSTRACT

A method, system and computer program product for sending a notification to a person moving through a zone and having a mobile device. In embodiments of the invention, the method comprises determining a speed of the person moving through the zone from movement of the mobile device as the mobile device moves with the person through the zone; identifying a condition for the speed of the person through the zone; and when the condition is satisfied, sending a notification to the mobile device. In embodiments of the invention a trigger is generated when the specified condition is satisfied; and the trigger initiates sending the notification to the mobile device. In embodiments of the invention, a defined speed is identified for the zone; and the condition is based on a comparison of the speed of the person moving through the zone with the defined speed for the zone.

### BACKGROUND

This invention generally relates to sending notifications to shoppers, and more specifically, to personalize when to send notifications to shoppers based on their speed in or through a zone.

With the use of in-store beacons and Wi-Fi technology, it is possible to track the movement of users/customers inside a store.

### SUMMARY

Embodiments of the invention provide a method, system and computer program product for sending a notification to a person moving through a given zone and having a mobile device. In embodiments of the invention, the method comprises determining a speed of the person moving through the given zone from movement of the mobile device as the mobile device moves with the person through the given zone; identifying a specified condition for the speed of the person through the given zone; and when the specified condition is satisfied, sending a notification to the mobile device.

In embodiments of the invention, the sending a notification to the mobile device includes generating a trigger when the specified condition is satisfied; and the trigger initiating the sending the notification to the mobile device.

In embodiments of the invention, the identifying a specified condition for the speed of the person through the given zone includes identifying a defined speed for the given zone; and the specified condition is based on a comparison of the speed of the person as the person moves through the given zone with the identified defined speed for the given zone.

Embodiments of the invention send a trigger to a device based on the speed of the user of the device at a specific location. Embodiments of the invention allow for venue operators to monitor the speed of a device in a zone and to produce a trigger to perform an action based on the monitored speed.

By monitoring this behavior, embodiments of the invention can provide context to the venue operators who are looking to intelligently and appropriately engage the customer.

Embodiments of the invention personalize when to send notifications to shoppers based on their speed in or through a zone.

Embodiments of the invention identify the speed of a device moving through a zone and provide a trigger based on a satisfied condition.

In embodiments of the invention, three different methods are used to achieve this:
A method that utilizes a “learning system” of the average speeds in a zone. By learning the average speed, a user is allowed to specify a “slow” or “fast” movement through a zone. The thresholds may be adjusted accordingly based on the device history of the zone movement.
A method to allow a venue operator to specify/hardcode what they would like to quantify as a “fast” or “slow” moving device in a zone.
A method to determine the speed of a person based on historical user data. For example, a shopper, Bob, is normally slow; if he walks fast, a trigger event is made. In comparison, a shopper, Emily, is normally fast; if she walks slow, a trigger event is made

Embodiments of the invention have a number of important advantages. For instance, using embodiments of the invention, companies can understand more about how their customers move through venues. Insights of human behavior can help stores fix potential problems and allow for a better customer experience. Also, companies can target the proper people for marketing purposes.

Embodiments of the invention may be used in a product or system that aggregates location and location-related metadata to build context that can be used for analysis and resulting actions. As such, part of the value that such a product provides is in its ability to analyze data from disparate sources and formulate accurate metrics. The ability to recognize customer actions is important and is of strategic value to the product and its customers.

### BRIEF DESCRIPTION OF THE SEVERAL VIEWS OF THE DRAWINGS

FIG. 1 schematically illustrates a method and system in accordance with an embodiment of the invention.

FIG. 2 shows the path of a shopper through a store in an example of the invention.

FIG. 3 shows the path of a second shopper through the store in another example of the invention.

FIG. 4 depicts a computer network that may be used in embodiments of the invention.

### DETAILED DESCRIPTION

Embodiments of the invention provide a method, system and computer program product for sending a notification to a person moving through a given zone and having a mobile device. In an embodiment, the method comprises determining a speed of the person moving through the given zone from movement of the mobile device as the mobile device moves with the person through the given zone; identifying a specified condition for the speed of the person through the given zone; and when the specified condition is satisfied, sending a notification to the mobile device.

Embodiments of the invention personalize when to send notifications to shoppers based on their speed in or through a zone.

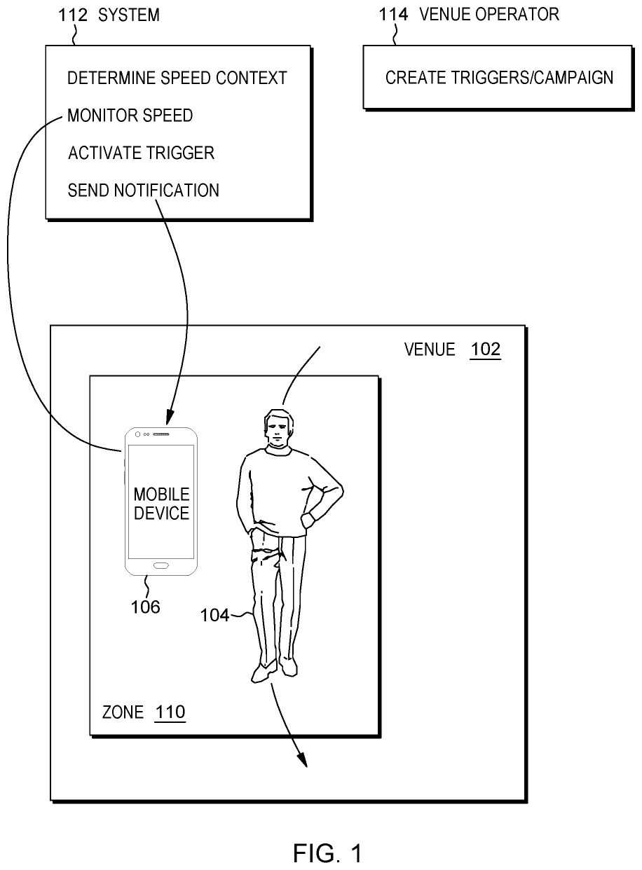

FIG. 1 schematically illustrates an embodiment of the invention. In an embodiment of the invention, a venue 102 is configured for location events, and known tools and technologies may be used to do this. FIG. 1 also shows a customer 104 with a mobile device 106 moving through a zone 110 of the venue 102. A system 112 utilizes one of the following methods to determine speed context: 1. Cognitive speed; 2. Hardcoded speed values; and 3. Historical speed.

The cognitive speed method is a method that utilizes a “learning system” of the average speeds in a zone. By learning the average speed over all visitors, a user is allowed to specify a “slow” or “fast” movement through a zone.

The hardcoded speed values method is a method to allow a venue operator to specify/hardcode what they would like to quantify as a “fast” or “slow” moving device in a zone (e.g., some distance over time).

The historical speed method is a method to determine the speed of a person based on historical user data (e.g., Bob is normally slow; if he walks fast, let's make a trigger event.)

In embodiments of the invention, a venue operator 114 creates triggers/campaigns based on speed. For example, when a device walks by at a fast speed, the venue operator may want a message sent that says: “Slow down! We have a great offer for you on laundry detergent.” As another example, when a device that typically goes fast, slows down, the venue operator may want a message sent that says: “I see you are looking at that toaster. Get it 20% off today!”

In embodiments of the invention, customers walk around venues with smart devices as they would today. System 112 monitors the speed of devices in a zone. System 112 activates triggers for the corresponding speeds in the respective zone.

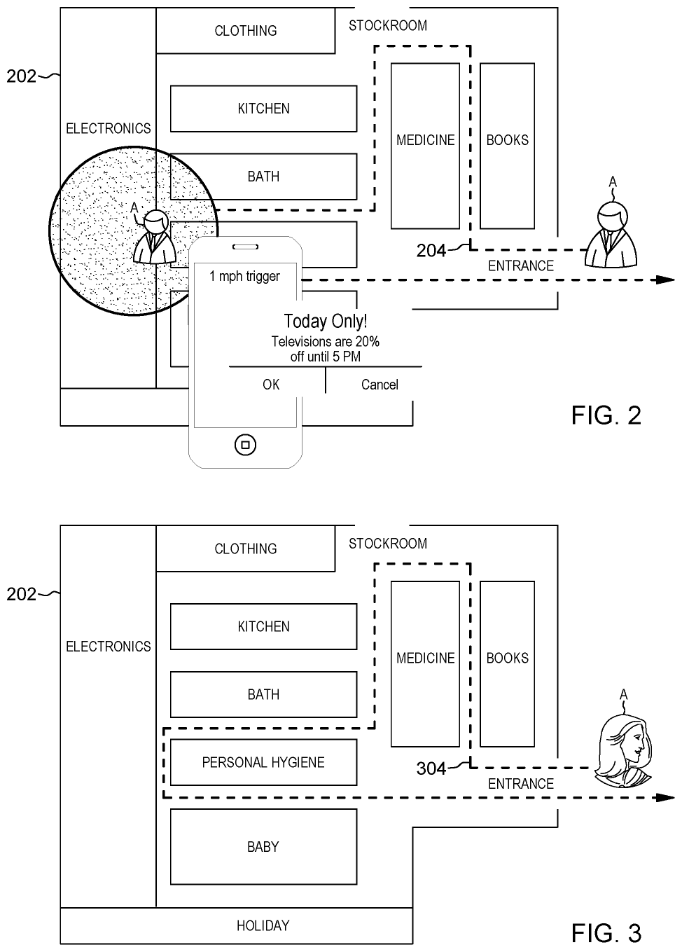

FIG. 2 shows an example of an embodiment of the invention. In this example, a shopper, Bob, is shopping through a store 202 and moves through the store on path 204. If Bob slows to one mile per hour, a trigger event might not occur because he is typically a slow shopper, so it is his normal behavior.

FIG. 3 illustrates another example of an embodiment of the invention. In this example, a shopper, Emily, moves through the store 202 on path 304. Emily is typically a “focused” shopper. She has a list of things she wants and moves very quickly through the store to get what is on her list and heads on her way. Using this invention, the system 104 recognizes that Emily normally moves at a speed of three miles per hour. A campaign is triggered such that if Emily slows to one mile per hour or less for thirty seconds, the event fires.

Emily's path through the store might look like this: Using the invention, the system 104 recognizes that Emily slows down near the electronics section. A marketer happens to have a dwell event for the electronics zone but the dwell event is set to five minutes. Emily only stays in the zone for two minutes (she is a fast shopper) but because her speed dropped to one mile per hour, it can be assumed, using the invention, that she is interested in something in the electronics section. Therefore, the system can pass along a campaign trigger event.

In embodiments of the invention, this system triggers a notification when a device hits a certain speed and fully enters and exits the zone. By doing this, the system makes sure that the device meant to fully exit the zone, rather than going fast directly to a location in that zone.

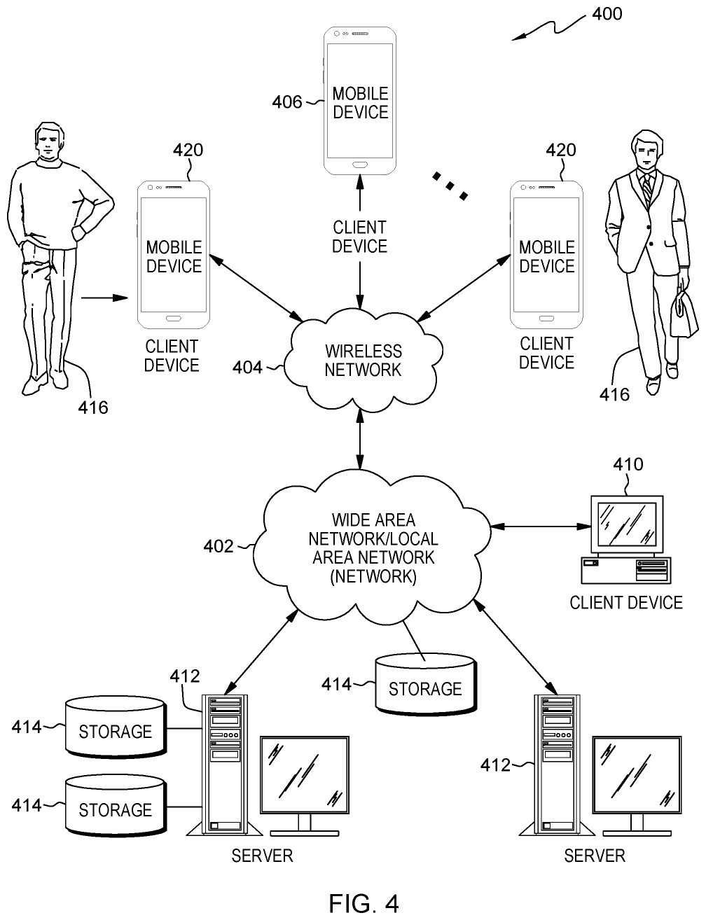

FIG. 4 shows components of a computing network 400 that may be used in embodiments of the invention. As shown, network 400 of FIG. 4 includes local area networks (“LANs”)/wide area network 402, wireless network 404, mobile devices 406, client device 410, servers 412, and data storage devices 414. FIG. 4 also shows customers 416, each of which has a mobile communications device 420.

Generally, mobile devices 406 and 420 may include virtually any portable computing device that is capable of receiving and sending a message over a network, such as networks 402 and wireless network 404. Such devices include portable devices such as cellular telephones and smart phones, and wearable devices such as smart watches, smart glasses and smart lenses. Mobile devices 406 and 420 may also include display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 406 and 420 typically range widely in terms of capabilities and features.

Wireless network 404 is configured to couple mobile devices 406 and 420 and their components with network 402. Wireless network 404 may include any of a variety of wireless sub-networks that may further overlay stand-alone ad-hoc networks, and the like, to provide an infrastructure-oriented connection for mobile devices 406 and 420. Such sub-networks may include mesh networks, Wireless LAN (WLAN) networks, cellular networks, and the like.

Each mobile communications device 406,420 may be connected to the network 404 in a manner that enables bi-directional communications. Thus, for example, one or all of the devices 406 and 420 may provide a signal to the network in order to provide a feedback or control signal to the servers 412. Likewise, the servers 412 may provide control signals to the network 404 in order to provide control signals to one or more of the mobile communications devices.

Client device 410 represents other suitable computing or processing devices that may be used in network 400. For instance, the client device 410 may comprise a personal computer, laptop computer, handheld computer, tablet computer, or Personal Digital Assistant (PDA). Device 410 may also include cellular telephones, smart phones, wearable computers and the like.

The servers 412 are configured to receive inputs from the mobile communications devices 406 and 420. The servers may process the input received from the devices 406, 420, in the manner discussed above.

Servers 412 include virtually any device that may be configured to provide an application service in network 400. Such application services or simply applications include, but are not limited to, email applications, search applications, video applications, audio applications, graphic applications, social networking applications, text message applications, or the like. In one embodiment, servers 412 may operate as web servers. However, servers 412 are not limited to web servers.

Storage devices 414 may comprise any suitable data storage devices, and the devices may be directly connected to one or more of the servers 412, or the storage devices may be accessed via network 402.

Network 402 is enabled to employ any form of computer readable media for communicating information from one electronic device to another. Also, network 402 can include the Internet in addition to local area networks (LANs), wide area networks (WANs), direct connections, such as through a universal serial bus (USB) port, other forms of computer-readable media, or any combination thereof.

A web-enabled mobile device used in or with network 300 may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices used in or with network 400 may each receive messages sent from servers 412, from one of the other mobile devices, or even from another computing device. Mobile devices 406, 420 may also send messages to one of servers 412, to other mobile devices, or to client device 410, or the like. Mobile devices 406, 420 may also communicate with non-mobile client devices, such as client device 410, or the like.

Those of ordinary skill in the art will appreciate that the architecture and hardware depicted in FIG. 4 may vary. Not all the illustrated components may be required to practice the invention, and variations in the arrangement and type of the components may be made without departing from the spirit or scope of the invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

1. A method of sending marketing messages personalized to a customer moving through a given zone in a shopping venue and having a mobile device, the method comprising:
determining a speed of the customer moving through the given zone in the shopping venue from movement of the mobile device as the mobile device moves with the customer through the given zone in the shopping venue;
identifying a specified condition for the speed of the customer moving through the given zone; and
when the specified condition of the speed of the customer moving through the given zone in the shopping venue is satisfied, triggering a marketing campaign for the zone of the shopping venue, and sending to the mobile device a personalized marketing message about the given zone, the personalized marketing message being personalized for the customer based on the speed of the customer as the customer moves through the given zone in the shopping venue.

2. The method according to claim 1, wherein the sending a message to the mobile device includes:
generating a trigger when the specified condition is satisfied; and
the trigger initiating the sending the message to the mobile device.

3. The method according to claim 1, wherein:
the identifying a specified condition for the speed of the customer through the given zone includes identifying a defined speed for the given zone; and
the specified condition is based on a comparison of the speed of the customer as the customer moves through the given zone with the identified defined speed for the given zone.

4. The method according to claim 3, wherein the identifying a defined speed for the given zone includes determining the defined speed based on a history of movements of a multitude of people through the given zone.

5. The method according to claim 3, wherein the identifying a defined speed for the given zone includes determining the defined speed from historical data about movement of the customer through the given zone.

6. The method according to claim 1, wherein:
the venue has a venue operator; and
the identifying a specified condition for the speed of the customer through the given zone includes the venue operator setting the specified condition.

7. The method according to claim 1, wherein:
the identifying a specified condition for the speed of the customer through the given zone includes identifying a plurality of specified conditions for the speed of the customer through the given zone, and matching each of the plurality of specified conditions with one of a plurality of given messages; and
the sending a notification to the mobile device includes, when one of the plurality of specified conditions is satisfied, sending to the mobile device the one of the given messages matched with the one of the plurality of specified conditions.

8. The method according to claim 1, further comprising:
generating a trigger that initiates the sending the notification to the mobile device;
generating a set of average speeds based on a threshold number of instances where the customer passed through the given zone; and
receiving a reply to a query sent to the mobile device to verify a matching of one or more of the speeds, in the set of average speeds, to a category of speed that is associated with the trigger.

9. The method according to claim 1, further comprising:
receiving, from the venue that includes the zone, one or more ranges that are respectively associated with categories of speed.

10. The method according to claim 1, further comprising:
generating a trigger that initiates the sending the message to the mobile device;
generating a set of average speeds based on a threshold number of instances where a plurality of users passed through the given zone; and
receiving a reply to a query sent to the mobile device to verify a matching of one or more speeds, in the set of average speeds, to a category of speed that is associated with the trigger.

11. A computer system for sending a marketing message personalized to a customer moving through a given zone in a shopping venue and having a mobile device, the computer system comprising:
a memory for storing data; and
one or more processing units connected to the memory for sending data to and receiving data from the memory, said one or more processing units configured for:
determining a speed of the customer moving through the given zone in the shopping venue from movement of the mobile device as the mobile device moves with the customer through the given zone in the shopping venue;
identifying a specified condition for the speed of the customer moving through the given zone; and
when the specified condition of the speed of the customer moving through the given zone in the shopping venue is satisfied, triggering a marketing campaign for the zone of the shopping venue, and sending a notification to the mobile device a personalized marketing message about the zone, the personalized marketing message being personalized for the customer based on the speed of the customer as the customer moves through the zone in the shopping venue.

12. The computer system according to claim 11, wherein the sending a message to the mobile device includes:
generating a trigger when the specified condition is satisfied; and
the trigger initiating the sending the message to the mobile device.

13. The computer system according to claim 11, wherein:
the identifying a specified condition for the speed of the customer through the given zone includes identifying a defined speed for the given zone; and
the specified condition is based on a comparison of the speed of the customer as the customer moves through the given zone with the identified defined speed for the given zone.

14. The computer system according to claim 13, wherein the identifying a defined speed for the given zone includes determining the defined speed based on a history of movements of a multitude of people through the given zone.

15. The computer system according to claim 13, wherein the identifying a defined speed for the given zone includes determining the defined speed from historical data about movement of the customer through the given zone.

16. A computer readable program storage device for sending a marketing message personalized to a customer moving through a given zone in a shopping venue and having a mobile device, the computer readable program storage device comprising:
a computer readable storage medium having program instructions embodied therein, the program instructions executable by a computer to cause the compute to perform the method of:
determining a speed of the customer moving through the given zone in the shopping venue from movement of the mobile device as the mobile device moves with the customer through the given zone in the shopping venue;
identifying a specified condition for the speed of the customer moving through the given zone; and
when the specified condition of the speed of the customer moving through the given zone in the shopping venue is satisfied, triggering a marketing campaign for the zone of the shopping venue, and sending to the mobile device a personalized marketing message about the given zone, the personalized marketing message being personalized for the customer based on the speed of the customer as the customer moves through the zone in the shopping venue.

17. (canceled)

18. The computer readable program storage device according to claim 16, wherein:
the identifying a specified condition for the speed of the customer through the given zone includes identifying a defined speed for the given zone; and
the specified condition is based on a comparison of the speed of the customer as the customer moves through the given zone with the identified defined speed for the given zone.

19. The computer readable program storage device according to claim 18, wherein the identifying a defined speed for the given zone includes determining the defined speed based on a history of movements of a multitude of people through the given zone.

20. (canceled)

21. The method according to claim 1, wherein:
the marketing campaign is a speed and location based marketing campaign for a product in the zone of the shopping venue; and
the marketing message for the customer is a marketing message for the product in the zone of the shopping venue and is based on the speed and location of the customer in the venue.

22. The method according to claim 1, wherein the sending to the mobile device a personalized marketing message includes triggering a notification when the mobile device hits a certain speed and fully enters and exits the given zone in the shopping venue.
